(19) United States
(12) Patent Application Publication
(10) Pub. No.: US 2026/0061404 A1
(43) Pub. Date: Mar. 5, 2026

(54) CO-LOADED CARBON-BASED CATALYST, PREPARATION METHOD AND APPLICATION THEREOF

(71) Applicant: Tianjin University, Tianjin (CN)

(72) Inventors: Guanyi CHEN, Tianjin (CN); Ning LI, Tianjin (CN); Haoxi DAI, Tianjin (CN); Yangli CUI, Tianjin (CN); Beibei YAN, Tianjin (CN); Zhanjun CHENG, Tianjin (CN); Xiaoqiang CUI, Tianjin (CN); Fawei LIN, Tianjin (CN)

(73) Assignee: Tianjin University, Tianjin (CN)

(21) Appl. No.: 18/926,330

(22) Filed: Oct. 25, 2024

(30) Foreign Application Priority Data
Sep. 3, 2024 (CN) 202411232212.2

(51) Int. Cl. B01J 27/20; B01J 23/75; B01J 35/40; B01J 37/04; B01J 37/08

(52) U.S. Cl. CPC B01J 27/20; B01J 23/75; B01J 35/40; B01J 37/04; B01J 37/084

(57) ABSTRACT

A Co-loaded carbon-based catalyst, a preparation method and application thereof are provided. Taking dopamine as a raw material, supplemented by a series of structural control methods, by regulating the preparation process parameters, the surface properties and structure of carbon-based catalysts are changed, the active sites of the catalysts are regulated, and an efficient Fenton-like system is constructed, thereby changing the persulfate activation pathway and the types of active species produced, and regulating the conversion pathway of refractory components in biogas slurry. The long-chain organic matter of lignin macromolecules in biogas slurry can be controlled into small molecular organic matter, which can improve the biodegradability of biogas slurry and promote its clean reuse.

### CROSS REFERENCE TO THE RELATED APPLICATIONS

This application is based upon and claims priority to Chinese Patent Application No. 202411232212.2, filed on Sep. 3, 2024, the entire contents of which are incorporated herein by reference.

### TECHNICAL FIELD

The present disclosure relates to the technical field of multifunctional water treatment purification materials, and in particular, to a Co-loaded carbon-based catalyst, a preparation method and application thereof.

### BACKGROUND

Biogas slurry is a kind of liquid substance produced by biodegradation and anaerobic fermentation of organic waste under the action of corresponding water content, temperature and methane bacteria conditions, and it has the characteristics of complex pollution components, poor biodegradability and unknown potential risks. The UV₂₅₄ value of the biogas slurry is 5.5-7.8 cm⁻¹, and the concentration of lignin which is difficult to degrade is as high as 3000-5200 mg/L. The uncertainty of biodegradability and biosafety of the biogas slurry is an important factor restricting the resource utilization of the biogas slurry, which is related to the different molecular weight distribution and composition characteristics of dissolved organic matter in the biogas slurry. In many methods to improve the biodegradability of wastewater, Fenton-like advanced oxidation has attracted wide attention due to its advantages of green, high efficiency, environmental friendliness and simple operation. The Fenton-like system has been applied to improve biodegradability of wastewater including wastewater containing antibiotics, biochemical tail water, landfill leachate, etc. However, in addition to the humic acids commonly found in biochemical tail water and landfill leachate, biogas slurry usually contains high concentrations of lignin, which has a network structure and contains a large number of aromatic rings, large molecular weight and good stability. Lignin usually needs to be converted into humic acid by chemical means or high temperature (170-195° C.), therefore, the lignin has more difficult to be biodegraded. In view of the above problems, it is necessary to innovate the Fenton-like system, including the design of the active site of the catalyst and the optimization of the Fenton-like system, so as to realize the efficient conversion of lignin and humic acid in biogas slurry and improve the biodegradability of biogas slurry. Therefore, it is particularly important to develop persulfate catalysts with high activity and specificity. At present, heterogeneous catalysts such as metal oxides and metal-loaded carbon materials have been studied in depth. The use of carbon-based materials as catalysts to construct a Fenton-like system to improve the biodegradability of refractory wastewater has been studied. However, the oxidation degree of organic matter in Fenton-like system is difficult to control, which leads to the mineralization of most organic matter and the waste of resources. The composition of oxide species can be changed by regulating an active site of the catalyst. thereby changing the conversion path of the organic component. However, it is difficult to regulate the active site and oxide species. and the development of highly selective Fenton-like technology for complex water bodies such as biogas slurry is challenging. There is still a lack of methods for the active site of the carbon-based catalyst to regulate the formation of oxide species in Fenton-like systems and the selective conversion of refractory components in biogas slurry, which hinders the application of carbon-based Fenton-like systems in improving the biodegradability of refractory wastewater.

### SUMMARY

A purpose of the present disclosure is to provide a Co-loaded carbon-based catalyst, a preparation method and application thereof, to solve the technical problem that the biodegradability of biogas slurry is insufficient in the prior art, and it is difficult to carry out high selective conversion of difficult biochemical degradation components in biogas slurry.

In order to achieve the above purpose, the present disclosure adopts the following technical solutions.

The present disclosure provides a preparation method for a Co-loaded carbon-based catalyst, including the following steps:
1) mixing cobalt chloride hexahydrate, dopamine, and H₂O₂ for reaction and drying, to obtain Co@PDA; and
2) performing thermal decomposition, washing, drying, and grinding in sequence on the Co@PDA obtained from step 1), to obtain Co-loaded carbon-based catalysts.

Further, in step 1), a dosage ratio of the cobalt chloride hexahydrate, dopamine and H₂O₂ is 3-200 mM:180-250 mM:0.8-1.5 mL.

Further, in step 1), a temperature of the mixed reaction is 18-40° C., and time of the mixed reaction is 8-12 h, a drying temperature is 130-200° C., and drying time is 1-5 h.

Further, in step 2), a temperature for the thermal decomposition is 600-800° C., time of the thermal decomposition is 2-4 h, and a heating rate of the thermal decomposition is 8-13° C./min.

Further, in step 2), a drying temperature is 60-80° C., and drying time is 10-15 h; and
a particle size of the grinding is over 80-150 mesh sieve.

The present disclosure provides a Co-loaded carbon-based catalyst prepared by the above preparation method.

The present disclosure further provides application of the Co-loaded carbon-based catalyst in activating persulfate to degrade organic components in biogas slurry, including adding Co-loaded carbon-based catalysts, biogas slurry, and peroxymonosulfate to a reaction vessel in turn, and stirring for reaction.

Further, a dosage ratio of the Co-loaded carbon-based catalysts, biogas slurry and peroxymonosulfate is 0.2-1.0 g:250-500 mL:2.0-6.0 mM.

Further, a concentration of chemical oxygen demand of the biogas slurry is 600-1000 mg/L, and a pH value of the biogas slurry is 3.0-11.0.

Further, a reaction temperature is 24-26° C., and reaction time is 1-3 h.

The beneficial effects of the present disclosure are:
(1) The Co-loaded carbon-based catalysts obtained by the present disclosure have a large specific surface area and rich active sites such as Co, lattice oxygen, and graphite N.
(2) The different Co-loaded carbon-based catalysts prepared by the present disclosure can activate peroxymonosulfate to produce active oxide species with different compositions (such as ¹O₂, ·OH and SO₄^{·-}).
(3) The peroxymonosulfate is activated by the Co-loaded carbon-based catalysts, and the biodegradability of the biogas slurry is improved by more than 37% after 90 min.

### BRIEF DESCRIPTION OF THE DRAWINGS

FIG. 1 shows XRD patterns of Co-loaded carbon-based catalysts obtained from Embodiments 1-4;

FIG. 2 shows XPS diagrams of Co-loaded carbon-based catalysts obtained from Embodiments 1-4;

FIG. 3 shows schematic diagrams of increasing proportion of Co-loaded carbon-based catalysts obtained from Embodiments 1-4 to biogas slurry; and

FIG. 4 shows UV spectra of biogas slurry after PMS activation by Co-loaded carbon-based catalysts obtained from Embodiments 1-4.

### DETAILED DESCRIPTION OF THE EMBODIMENTS

The present disclosure provides a preparation method for a Co-loaded carbon-based catalyst, including the following steps:
1) mixing cobalt chloride hexahydrate, dopamine, and H₂O₂ for reaction and drying, to obtain Co@PDA; and
2) performing thermal decomposition, washing, drying, and grinding in sequence on the Co@PDA obtained from step 1), to obtain Co-loaded carbon-based catalysts.

In the present disclosure, in step 1), a dosage ratio of the cobalt chloride hexahydrate, dopamine and H₂O₂ is 3-200 mM:180-250 mM:0.8-1.5 mL, preferably 10-150 mM:200-230 mM:1-1.3 mL, further preferably 30-100 mM:220 mM:1.2 mL, and more preferably 50 mM:220 mM:1.2 mL.

In the present disclosure, in step 1), a temperature of the mixed reaction is 18-40° C., preferably 20-35° C., further preferably 25-30° C., and more preferably 28° C.; time of the mixed reaction is 8-12 h, preferably 9-11 h, and further preferably 10 h; a drying temperature is 130-200° C., preferably 150-180° C., and further preferably 165° C.; and drying time is 1-5 h, preferably 2-4 h, and further preferably 3 h.

In the present disclosure, in step 2), a temperature for the thermal decomposition is 600-800° C., preferably 650-750° C., and further preferably 700° C.; time of the thermal decomposition is 2-4 h, and preferably 3 h; and a heating rate of the thermal decomposition is 8-13° C./min, preferably 9-12° C./min, and further preferably 10° C./min.

In the present disclosure, in step 2), a drying temperature is 60-80° C., preferably 65-75° C., and further preferably 70° C.; drying time is 10-15 h, and preferably 13 h; and
a particle size of the grinding is over 80-150 mesh sieve, preferably 100-130 mesh sieve, and further preferably 120 mesh sieve.

In the present disclosure, the washing is preferably to wash with deionized water and ethanol until neutral and then drying.

The present disclosure provides a Co-loaded carbon-based catalyst prepared by the above preparation method.

The present disclosure further provides application of the Co-loaded carbon-based catalyst in activating persulfate to degrade organic components in biogas slurry, including mixing Co-loaded carbon-based catalysts, biogas slurry, and peroxymonosulfate in sequence for reaction.

In the present disclosure, a dosage ratio of the Co-loaded carbon-based catalysts, biogas slurry and peroxymonosulfate is 0.2-1.0 g:250-500 mL:2.0-6.0 mM, preferably 0.5-0.8 g:300-450 mL:3.0-5.0 mM, further preferably 0.7 g:350-400 mL:4 mM, and more preferably 0.7 g:370 mL:4 mM.

In the present disclosure, a concentration of chemical oxygen demand of the biogas slurry is 600-1000 mg/L, preferably 700-900 mg/L, and further preferably 800 mg/L; and a pH value of the biogas slurry is 3.0-11.0, preferably 5.0-8.0, and further preferably 7.0.

In the present disclosure, a reaction temperature is 24-26° C., and preferably 25° C.; and reaction time is 1-3 h, preferably 1.5-2.5 h, and further preferably 2 h.

In the present disclosure, five-day biochemical oxygen demand (BOD₅), COD value and conversion products of biogas slurry after Fenton-like reaction are determined by ultraviolet full spectrum test.

In the following, the technical solutions provided by the present disclosure are described in detail in combination with embodiments, but they cannot be understood as limiting the scope of protection of the present disclosure.

### Embodiment 1

200 mM cobalt chloride hexahydrate (CoCl₂·6H₂O), 200 mM dopamine and 1 mL H₂O₂ were mixed at 25° C. for reaction for 10 h, and then dried in an oven at 160° C. for 2 h, to obtain a precursor Co@PDA; Co @ PDA was pyrolyzed in a tube furnace (the pyrolysis temperature was 800° C., the pyrolysis time was 4 h, and the heating rate was 10° C/min), then, the pyrolysis product was washed with deionized water and ethanol until neutral, dried in an oven at 60° C. for 12 h, and then ground through a 100-mesh sieve, to obtain Co-loaded carbon-based catalysts, denoted as Co@CN-1:1; and
at 25° C., 0.25 g catalyst powder was added to 250 mL biogas slurry with chemical oxygen demand (COD) concentration of 800 mg/L and pH value of 8.0. The pH value of the solution remained stable throughout the reaction. Subsequently, 4.0 mM persulfate was added to the mixed solution. After 2 h of reaction, the catalysts were separated from the biogas slurry and the biogas slurry was determined.

### Embodiment 2

40 mM cobalt chloride hexahydrate (CoCl₂·6H₂O), 200 mM dopamine and 1 mL H₂O₂ were mixed at 35° C. for 10 h, and then dried in an oven at 160° C. for 2 h, to obtain a precursor Co@PDA; Co@PDA was pyrolyzed in a tube furnace (the pyrolysis temperature was 800° C., the pyrolysis time was 2 h, and the heating rate was 8° C/min), then the pyrolysis product was washed with deionized water and ethanol until neutral, dried in an oven at 60° C. for 12 h, then ground through a 100-mesh sieve, to obtain Co-loaded carbon-based catalysts, denoted as Co@CN-1:5; and
at 24° C., 0.125 g catalyst powder was added to 500 mL biogas slurry with chemical oxygen demand (COD) concentration of 800 mg/L and pH value of 8.0. The pH value of the solution remained stable throughout the reaction. Subsequently, 3.0 mM peroxymonosulfate was added to the mixed solution. After 1.5 h of reaction, the catalysts were separated from the biogas slurry and the biogas slurry was determined.

### Embodiment 3

20 mM cobalt chloride hexahydrate (CoCl₂·6H₂O), 200 mM dopamine and 1 mL H₂O₂ was mixed at 18° C. for reaction for 10 h, and then dried in an oven at 160° C. for 2 h, to obtain a precursor Co@PDA; Co@PDA was pyrolyzed in a tube furnace (the pyrolysis temperature was 800° C., the pyrolysis time was 4 h, and the heating rate was 10° C/min), then, the pyrolysis product was washed with deionized water and ethanol to neutral, dried in an oven at 60° C. for 12 h, and then ground through a 100-mesh sieve, to obtain Co-loaded carbon-based catalysts, denoted as Co@CN-1:10; and
at 26° C., 0.125 g catalyst powder was added to 250 mL biogas slurry with chemical oxygen demand (COD) concentration of 750 mg/L and pH value of 7.8. The pH value of the solution remained stable throughout the reaction. Subsequently, 4.0 mM persulfate was added to the mixed solution. After 2 h of reaction, the catalyst was separated from the biogas slurry and the biogas slurry was determined.

### Embodiment 4

3.3 mM cobalt chloride hexahydrate (CoCl₂·6H₂O), 200 mM dopamine and 1 mL H₂O₂ were stirred at 25° C. for reaction for 10 h, and then dried in an oven at 160° C. for 2 h, to obtain Co@PDA; Co@PDA was pyrolyzed in a tube furnace (the pyrolysis temperature was 800° C., the pyrolysis time was 4 h, and the heating rate was 10° C/min), then, the pyrolysis product was washed with deionized water and ethanol to neutral, dried in an oven at 60° C. for 12 h, and then ground through a 100-mesh sieve, to obtain Co-loaded carbon-based catalysts, denoted as Co@CN-1:60; and
at 24° C., 0.5 g catalyst powder was added to 500 mL biogas slurry with chemical oxygen demand (COD) concentration of 750 mg/L and pH of 7.8. The pH value of the solution remained stable throughout the reaction. Subsequently, 3.0 mM peroxymonosulfate was added to the mixed solution. After 1.5 h of reaction, the catalysts were separated from the biogas slurry and the biogas slurry was determined.

### Embodiment 5

200 mM cobalt chloride hexahydrate (CoCl₂·6H₂O), 200 mM dopamine and 1.5 mL H₂O₂ were stirred at 18° C. for reaction for 10 h, and then dried in an oven at 200° C. for 1 h, to obtain Co@PDA; Co@PDA was pyrolyzed in a tube furnace (the pyrolysis temperature was 800° C., the pyrolysis time was 2 h, and the heating rate was 13° C/min), then, the pyrolysis product was washed with deionized water and ethanol to neutral, dried in an oven at 80° C. for 10 h, and then ground through a 150-mesh sieve, to obtain Co-loaded carbon-based catalysts; and
at 26° C., 1 g catalyst powder was added to 500 mL biogas slurry with chemical oxygen demand (COD) concentration of 1000 mg/L and pH of 3.0. The pH value of the solution remained stable throughout the reaction. Subsequently, 6.0 mM peroxymonosulfate was added to the mixed solution. After 3 h of reaction, the catalyst was separated from the biogas slurry and the biogas slurry was determined.

### Embodiment 6

100 mM cobalt chloride hexahydrate (CoCl₂·6H₂O), 200 mM dopamine and 0.8 mL H₂O₂ were stirred at 35° C. for reaction for 8 h, and then dried in an oven at 130° C. for 5 h, to obtain Co@PDA, then Co@PDA was pyrolyzed in a tube furnace (the pyrolysis temperature was 600° C., the pyrolysis time was 4 h, and the heating rate was 8° C/min), then, the pyrolysis product was washed with deionized water and ethanol to neutral, dried in an oven at 60° C. for 15 h, and then ground through a 80-mesh sieve, to obtain Co-loaded carbon-based catalysts; and
at 25° C., 0.2 g catalyst powder was added to 250 mL biogas slurry with chemical oxygen demand (COD) concentration of 600 mg/L and pH of 11.0. The pH value of the solution remained stable throughout the reaction. Subsequently, 2.0 mM persulfate was added to the mixed solution. After 3 h of reaction, the catalyst was separated from the biogas slurry and the biogas slurry was determined.

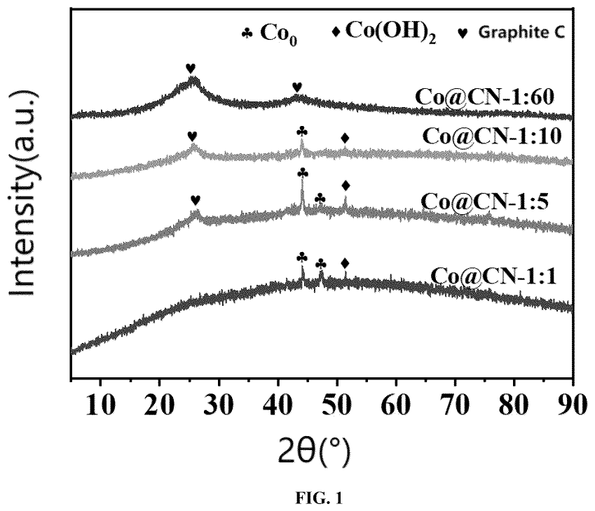

It can be seen from the above embodiments that the present disclosure provides a Co-loaded carbon-based catalyst, a preparation method and application thereof. FIG. 1 shows the XRD patterns of Co-loaded carbon-based catalysts obtained from embodiments 1-4. It can be seen from the figure that each XRD pattern of Co@CN-1:5, Co@CN-1:10 and Co@CN-1:60 shows a strong peak at 25°, and the peak shape is wider, corresponding to the (002) diffraction of graphite carbon, two characteristic diffraction peaks of cobalt appear at 44.2° and 47.5°, respectively, which indicating that the cobalt salt is successfully reduced to elemental cobalt during the preparation of the catalyst. The diffraction peak of the Co@CN-1:1 sample at 47.5° is the strongest, which is related to the high Co loading of the sample. In addition, Co@CN-1:1, Co@CN-1:5 and Co@CN-1:10 samples have obvious sharp peaks at 51.3°, which belong to the characteristic peaks of Co(OH)₂.

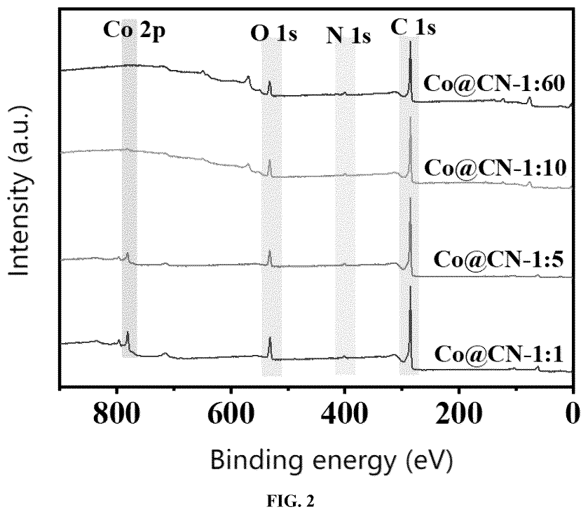

FIG. 2 shows XPS diagrams of the Co-loaded carbon-based catalysts obtained from Embodiments 1 to 4. As shown in FIG. 2, the Co contents in Co@CN-1:1, Co@CN-1:5, Co@CN-1:10 and Co@CN-1:60 are 4.88%, 3.22%, 0.91% and 0.74%, respectively. The higher the Co content of the catalysts, the higher the intensity of the Co 2p characteristic peak. In addition, the contents of N in Co@CN-1:1, Co@CN-1:5, Co@CN-1:10 and Co@CN-1:60 are 2.19%, 2.65%, 2.28% and 4.06%, respectively, wherein the N content of Co@CN-1:60 is higher, which may be related to the high content of dopamine precursor.

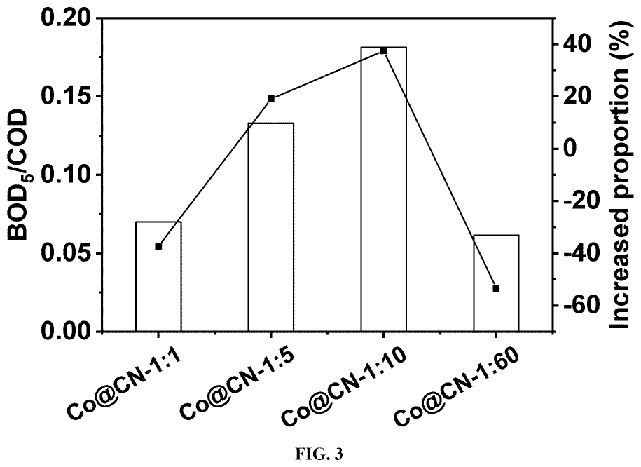

FIG. 3 shows schematic diagrams of the increase in the biodegradability of biogas slurry by Co-loaded carbon-based catalysts obtained from Embodiments 1-4. It can be seen from the figure that when a mixing ratio of Co and PDA is 1:1, the biodegradability of biogas slurry decreases. With the decrease of Co content, the biodegradability of biogas slurry increases to 0.13, and the increase ratio is 19.0%, when a ratio of Co to PDA is 1:10, after 1.5 h of reaction, the B/C of biogas slurry reaches 0.18, and the increase ratio of the biodegradability is 37.4%.

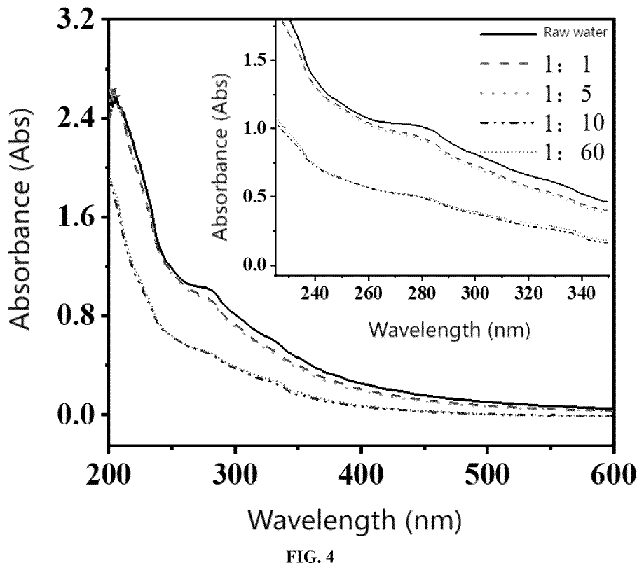

FIG. 4 shows UV spectra of biogas slurry after PMS activation by Co-loaded carbon-based catalysts obtained from Embodiments 1-4. The intensity and position of the UV absorption peak are related to the type and content of organic matter in water samples, and are usually related to unsaturated compounds and polycyclic aromatic compounds containing C═C and C═O. When the wavelength is greater than 400 nm, the absorbance of the untreated biogas slurry and the samples after oxidation treatment is generally smaller, and there is no obvious absorbance peak. As shown in FIG. 4, the raw water has an obvious characteristic peak at 250-280 nm, which is due to the presence of a large amount of humic acid, lignosulphonic acid and its derivatives in the untreated biogas slurry. These substances are prone to π-π electron transitions, resulting in an absorption peak at 280 nm. The intensity of the characteristic peak at 250-280 nm in the samples is weakened after the PMS oxidation treatment is activated by the four catalysts, which indicates that the humic acid and lignosulfonate are effectively degraded in the four systems. In addition, after Fenton-like oxidation, a low-intensity absorption platform appears at 220-250 nm, which may be related to the conjugated double bond organics in the oxidation products.

In summary, the present disclosure provides an accurate strategy for the regulation of active sites and oxide species and the controllable transformation of refractory biodegradable components. Taking dopamine as a raw material, supplemented by a series of structural control methods, by regulating the preparation process parameters, the present disclosure changes the surface properties and structure of carbon-based catalysts, regulates the active sites of the catalysts, and constructs an efficient Fenton-like system, thereby changing the persulfate activation pathway and the types of active species produced, and regulating the conversion pathway of refractory components in biogas slurry. The long-chain organic matter of lignin macromolecules in biogas slurry can be controlled into small molecular organic matter, which can improve the biodegradability of biogas slurry and promote its clean reuse.

The above are only the preferred embodiments of the present disclosure, it should be pointed out that for ordinary technical personnel in the technical field, without deviating from the principle of the present disclosure, a number of improvements and retouchings can be made, which should also be regarded as the protection scope of the present disclosure.

What is claimed is:

1. A preparation method for a Co-loaded carbon-based catalyst, comprising the following steps:
1) mixing cobalt chloride hexahydrate, dopamine, and H₂O₂ for a first reaction and drying, to obtain Co@PDA; and
2) performing thermal decomposition, washing, drying, and grinding in sequence on the Co@PDA obtained from the step 1), to obtain the Co-loaded carbon-based catalyst.

2. The preparation method for the Co-loaded carbon-based catalyst according to claim 1, wherein in the step 1), a dosage ratio of the cobalt chloride hexahydrate, the dopamine, and the H₂O₂ is 3-200 mM:180-250 mM:0.8-1.5 mL.

3. The preparation method for the Co-loaded carbon-based catalyst according to claim 1, wherein in the step 1), a temperature of the first reaction is 18-40° C., and a time of the first reaction is 8-12 h, a drying temperature is 130-200° C., and a drying time is 1-5 h.

4. The preparation method for the Co-loaded carbon-based catalyst according to claim 3, wherein in the step 2), a temperature for the thermal decomposition is 600-800° C., a time of the thermal decomposition is 2-4 h, and a heating rate of the thermal decomposition is 8-13° C./min.

5. The preparation method for the Co-loaded carbon-based catalyst according to claim 1, wherein in the step 2), a drying temperature is 60-80° C., and a drying time is 10-15 h; and
a particle size of the grinding is over 80-150 mesh sieve.

6. A Co-loaded carbon-based catalyst prepared by the preparation method according to claim 1.

7. A method of using the Co-loaded carbon-based catalyst according to claim 6 in activating persulfate to degrade organic components in a biogas slurry, comprising adding the Co-loaded carbon-based catalyst, the biogas slurry, and peroxymonosulfate to a reaction vessel in turn, and stirring for a second reaction.

8. The method of using the Co-loaded carbon-based catalyst according to claim 7, wherein a dosage ratio of the Co-loaded carbon-based catalyst, the biogas slurry, and the peroxymonosulfate is 0.2-1.0 g:250-500 mL:2.0-6.0 mM.

9. The method of using the Co-loaded carbon-based catalyst according to claim 7, wherein a concentration of a chemical oxygen demand of the biogas slurry is 600-1000 mg/L, and a pH value of the biogas slurry is 3.0-11.0.

10. The method of using the Co-loaded carbon-based catalyst according to claim 7, wherein a temperature of the second reaction is 24-26° C., and a time of the second reaction is 1-3 h.

11. The preparation method for the Co-loaded carbon-based catalyst according to claim 2, wherein in the step 1), a temperature of the first reaction is 18-40° C., and a time of the first reaction is 8-12 h, a drying temperature is 130-200° C., and a drying time is 1-5 h.

12. The preparation method for the Co-loaded carbon-based catalyst according to claim 11, wherein in the step 2), a temperature for the thermal decomposition is 600-800° C., a time of the thermal decomposition is 2-4 h, and a heating rate of the thermal decomposition is 8-13° C./min.

13. The preparation method for the Co-loaded carbon-based catalyst according to claim 2, wherein in the step 2), a drying temperature is 60-80° C., and a drying time is 10-15 h; and
a particle size of the grinding is over 80-150 mesh sieve.

14. The preparation method for the Co-loaded carbon-based catalyst according to claim 4, wherein in the step 2), a drying temperature is 60-80° C., and a drying time is 10-15 h; and
a particle size of the grinding is over 80-150 mesh sieve.

15. The preparation method for the Co-loaded carbon-based catalyst according to claim 12, wherein in the step 2), a drying temperature is 60-80° C., and a drying time is 10-15 h; and
a particle size of the grinding is over 80-150 mesh sieve.

16. The Co-loaded carbon-based catalyst according to claim 6, wherein in the step 1) of the preparation method, a dosage ratio of the cobalt chloride hexahydrate, the dopamine, and the H₂O₂ is 3-200 mM:180-250 mM:0.8-1.5 mL.

17. The Co-loaded carbon-based catalyst according to claim 6, wherein in the step 1) of the preparation method, a temperature of the first reaction is 18-40° C., and a time of the first reaction is 8-12 h, a drying temperature is 130-200° C., and a drying time is 1-5 h.

18. The Co-loaded carbon-based catalyst according to claim 17, wherein in the step 2) of the preparation method, a temperature for the thermal decomposition is 600-800° C., a time of the thermal decomposition is 2-4 h, and a heating rate of the thermal decomposition is 8-13° C./min.

19. The Co-loaded carbon-based catalyst according to claim 6, wherein in the step 2) of the preparation method, a drying temperature is 60-80° C., and a drying time is 10-15 h; and
a particle size of the grinding is over 80-150 mesh sieve.

20. The method of using the Co-loaded carbon-based catalyst according to claim 8, wherein a concentration of a chemical oxygen demand of the biogas slurry is 600-1000 mg/L, and a pH value of the biogas slurry is 3.0-11.0.
